(19) United States
(12) Patent Application Publication
(10) Pub. No.: US 2005/0003735 A1
(43) Pub. Date: Jan. 6, 2005

(54) Transmitter adaptable for left-handed or right-handed use

(75) Inventors: Joel Carter, Cedar Hill, TX (US); Chan Yeung, Hong Kong (HK); Bill Yeung, Hong Kong (HK)

Correspondence Address: HAYNES AND BOONE, LLP, 901 MAIN STREET, SUITE 3100, DALLAS, TX, 75202, US

(73) Assignee: RadioShack Corporation, Fort Worth, TX (US)

(21) Appl. No.: 10/611,046

(22) Filed: Jul. 1, 2003

(51) Int. Cl. H04B 7/24; A63H 30/00; A63H 30/04

(52) U.S. Cl. 446/456; 446/454

(57) ABSTRACT

A transmitter is described, which is adaptable for left-handed or right-handed use. The transmitter includes a selector for selecting left-handed or right-handed use of the transmitter. Upon selection of right-handed use, actuation of a control member of the transmitter causes a predefined response by a radio-controlled toy associated with the transmitter. The transmitter further includes selection circuitry associated with the selector and the control member. Upon selection of left-handed use, the selection circuitry reverses the predefined response of the toy when the control member is actuated.

### CROSS-REFERENCE TO RELATED APPLICATIONS

This invention is related to U.S. patent application Ser. No. (Attorney Docket No. 2030.67), entitled “Channel Selector for Selecting an Operating Frequency” (Inventors: Man Lung Lam, Sze Ming Patrick Kwong, and Man Tai Vincent Lam) and U.S. patent application Ser. No. (Attorney Docket No. 2030.69), entitled “Radio Frequency Toy Controller Design” (Inventor: Chan Yeung), both of which were filed on the same day as the present application.

### BACKGROUND

This disclosure relates generally to radio-controlled mobile toys and, more specifically, to a transmitter for radio-controlled toys.

A radio-controlled toy, such as a radio-controlled car, is generally operated by a transmitter, which transmits radio signals to the radio-controlled car. Such transmitters are typically configured for one of either left-handed or right-handed use. Thus, separate transmitters are required for left-handed and right-handed users. This may be both inconvenient and expensive, as additional effort is expended by manufacturers to provide the separate transmitters, and users may need to purchase additional transmitters to ensure that anyone desiring to use their radio-controlled car may do so.

Therefore, what is needed is a transmitter, which is adaptable for left-handed or right-handed use.

### SUMMARY

A transmitter is provided, which is adaptable for left-handed or right-handed use. The transmitter includes a selector for selecting left-handed or right-handed use of the transmitter. Upon selection of right-handed use, actuation of a control member of the transmitter causes a predefined response by a radio-controlled toy associated with the transmitter. The transmitter further includes selection circuitry associated with the selector and the control member. Upon selection of left-handed use, the selection circuitry reverses the predefined response of the toy when the control member is actuated.

In another embodiment, a transmitter for a radio-controlled toy is provided. The transmitter is adaptable for a left-handed or right-handed user, and includes a housing having a cutout formed therein. A configuration switch on the housing is in electrical communication with a configuration circuit positioned within the housing. The configuration switch is selectable between a left position and a right position in which the left position configures the transmitter for use by a left-handed user and the right position configures the transmitter for use by a right-handed user. A control member is positioned in the cutout of the housing and is movable in first and second directions, which are substantially opposite to one another. Movement of the control member imparts motion to the radio-controlled toy, such motion being dependent upon the setting of the configuration switch.

In yet another embodiment, a method for altering a behavior of a transmitter depending on whether the transmitter is configured for use by a right-handed or left-handed user is provided. The transmitter includes a selector associated with a configuration circuit. The method includes reading an output of the configuration circuit to determine whether the selector is set for right-handed or left-handed use, generating a first signal if the selector is set for right-handed use and generating a second signal different from the first signal if the selector is set for left-handed use, and transmitting the first or second signal to a radio-controlled toy being controlled by the transmitter. The behavior of the radio-controlled toy is dependent on whether the selector is set for right-handed or left-handed use.

In yet another embodiment, a system for correcting steering drift in a radio-controlled toy is provided. The system includes a radio transmitter having steering control circuitry for receiving steering input, a steering adjuster associated with the steering control circuitry for correcting steering drift associated with a radio-controlled toy, and signal transmission circuitry for transmitting radio signals from the steering control circuitry. The radio-controlled toy includes motor control circuitry for steering the toy using the radio signals from the transmitter, and a trimmer associated with the motor control circuitry. The trimmer is adjustable to correct steering drift associated with the toy.

### BRIEF DESCRIPTION OF THE DRAWINGS

FIG. 1 is a perspective view of a transmitter and a radio-controlled car according to one embodiment of the present disclosure.

FIG. 2 is a front view of the transmitter of FIG. 1.

FIG. 3 is a rear view of the transmitter of FIG. 1.

FIG. 4 is a bottom view of the radio-controlled car of FIG. 1.

FIG. 5A is an exemplary circuit diagram for the transmitter of FIG. 1 illustrating a channel selection circuit, a left hand/right hand selection circuit, and a control circuit for a microcontroller unit.

FIG. 5B is an exemplary circuit diagram for the transmitter of FIG. 1 illustrating a forward/backward motion control circuit.

FIG. 5C is an exemplary circuit diagram for the transmitter of FIG. 1 illustrating a left/right steering circuit.

FIG. 5D is an exemplary circuit diagram of a signal transmission circuit located in the transmitter of FIG. 1.

FIG. 5E is an exemplary circuit diagram of a charging circuit located in the transmitter of FIG. 1.

FIG. 5F is an exemplary circuit diagram of a light emitting diode (LED) circuit located in the transmitter of FIG. 1.

FIG. 5G is a diagram illustrating a first position of an exemplary left hand/right hand selection switch associated with the transmitter of FIG. 1.

FIG. 5H is a diagram illustrating a second position of the exemplary left hand/right hand selection switch of FIG. 5G.

FIG. 6A is an exemplary circuit diagram for the radio-controlled car of FIG. 1 illustrating a low noise amplifier, a receiver circuit, and a control circuit for a microcontroller unit.

FIG. 6B is an exemplary circuit diagram of a first motor control circuit located in the radio-controlled car of FIG. 1.

FIG. 6C is an exemplary circuit diagram of a second motor control circuit located in the radio-controlled car of FIG. 1.

FIG. 6D is an exemplary circuit diagram of a DC-DC converter circuit located in the radio-controlled car of FIG. 1.

### DETAILED DESCRIPTION

This disclosure relates generally to radio-controlled mobile toys and, more specifically, to a transmitter adaptable for left-handed or right-handed use. It is understood, however, that the following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

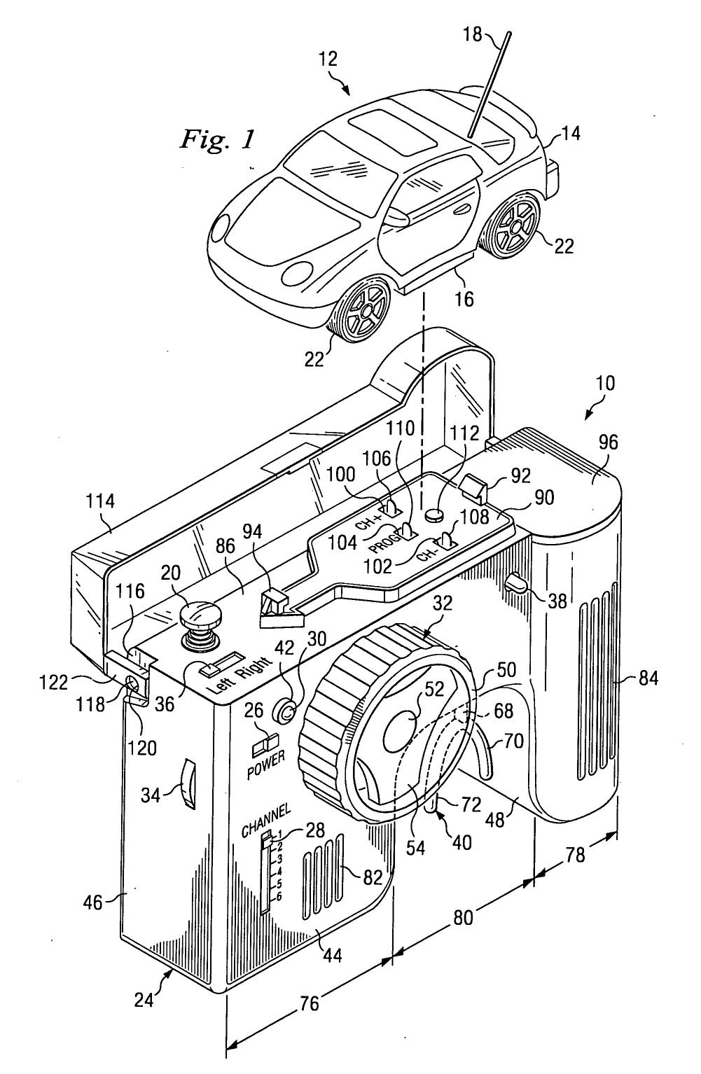

Referring to FIGS. 1-3, in one embodiment, a transmitter 10 may be used to control a radio-controlled toy 12. For purposes of example, the radio-controlled toy 12 is a radio-controlled car that includes a body 14 and a chassis 16. The body 14 may connect to the chassis 16 in a variety of ways, including a conventional pressure fit or a snap connection. Accordingly, various configurations of the body 14 may be used with the chassis 16. The radio-controlled car 12 further includes a set of wheels 22 associated with the chassis 16.

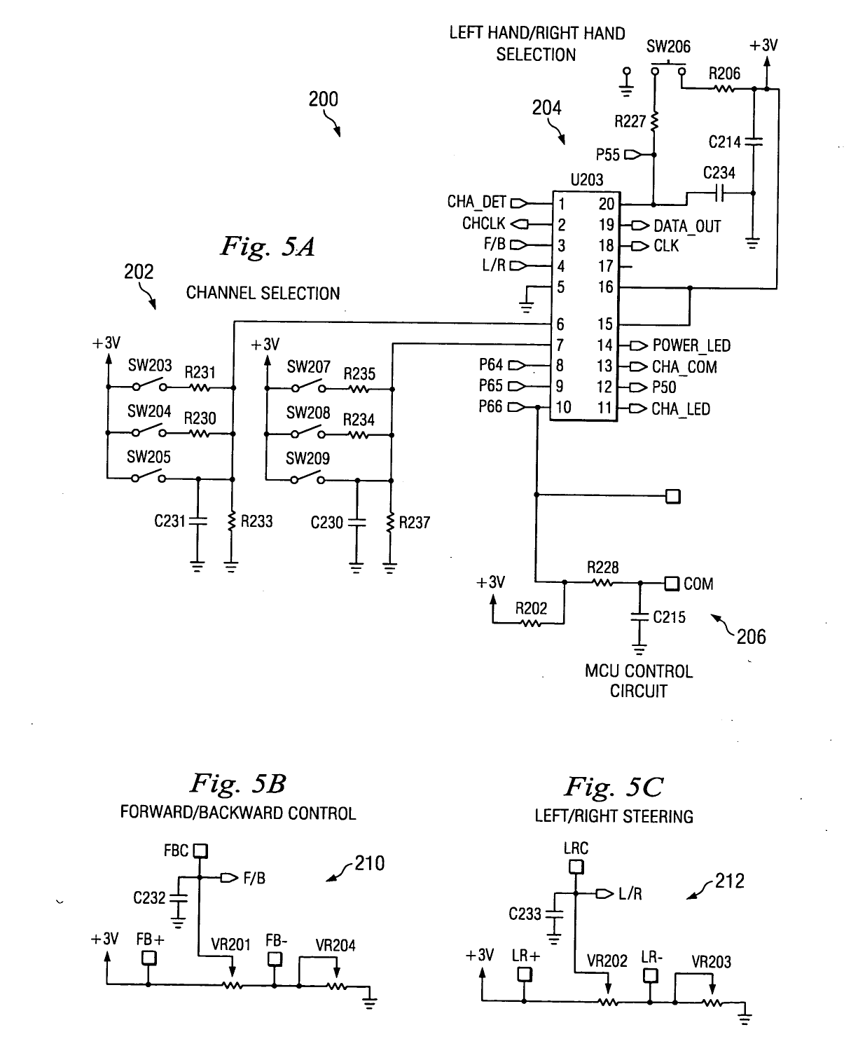

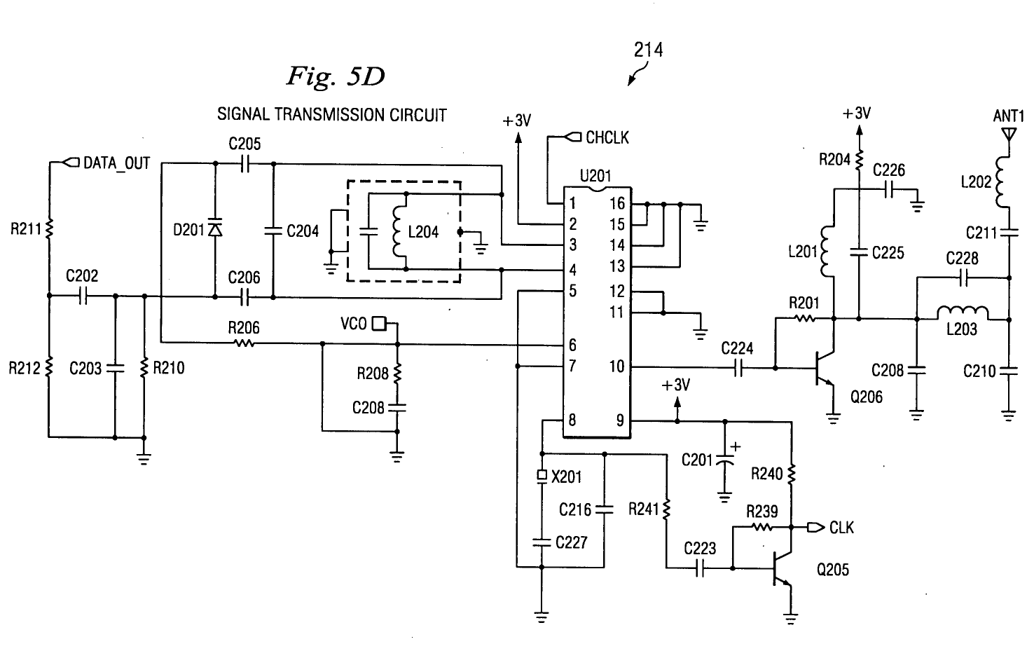

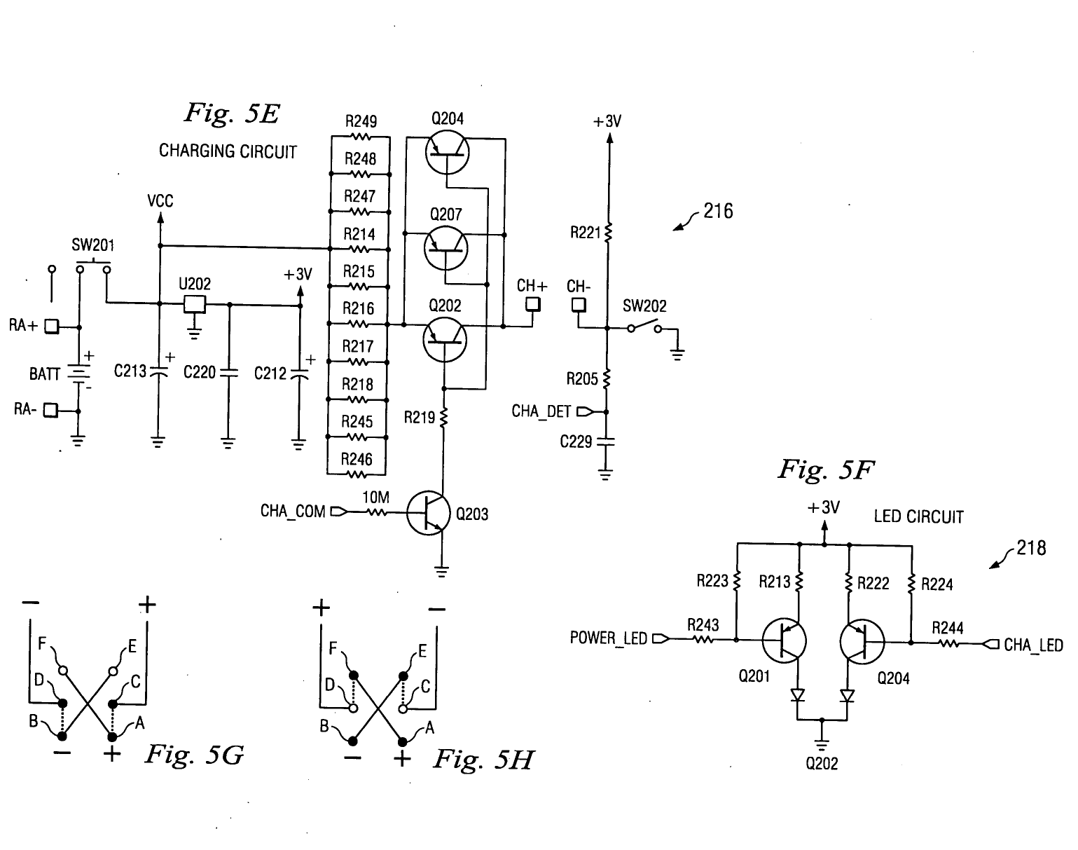

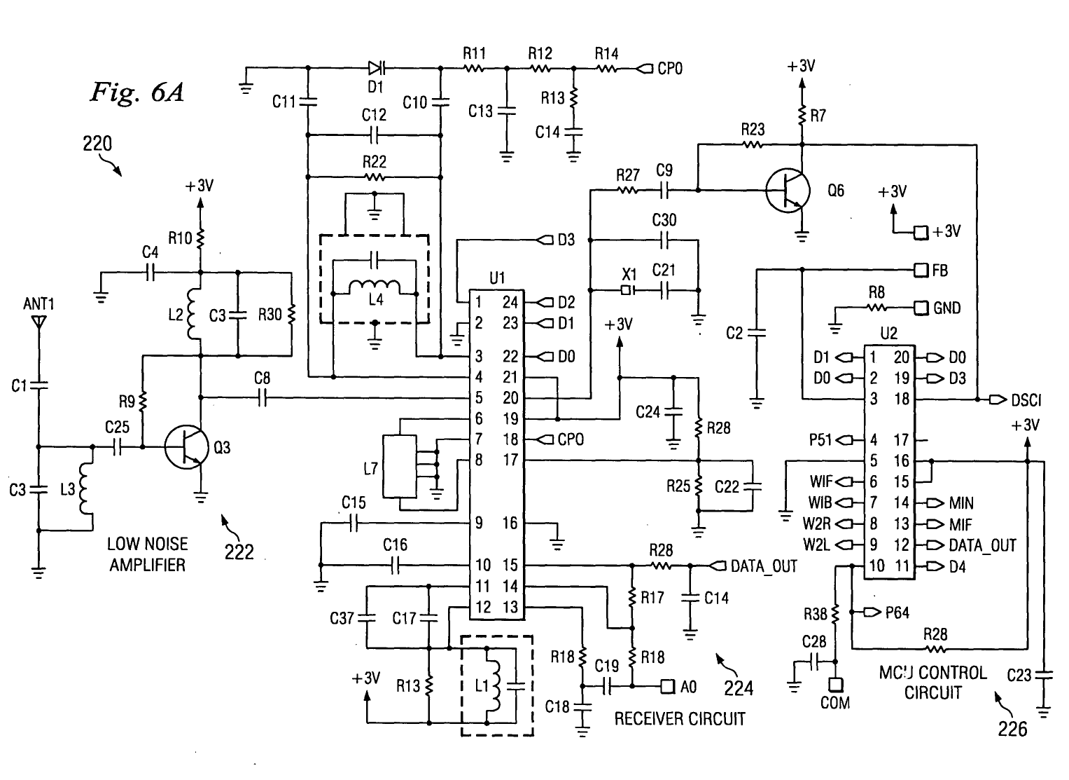

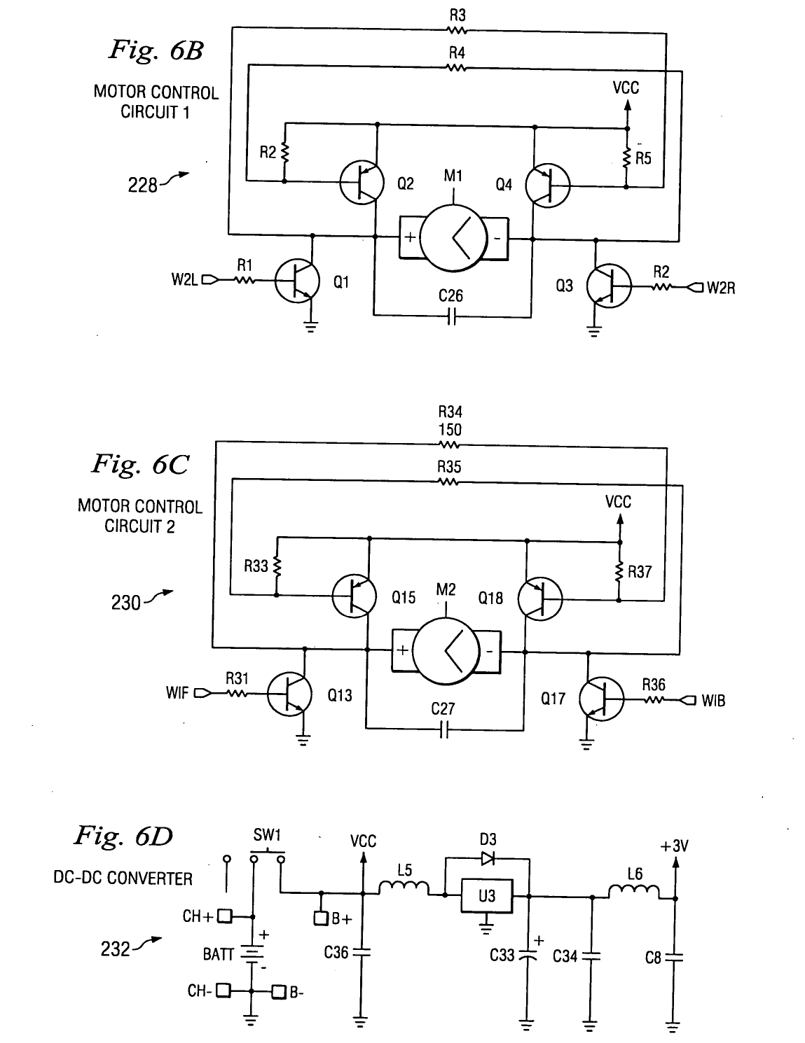

A plurality of electronic circuits (FIGS. 5A-6D) are housed within the transmitter 10 and the radio-controlled car 12. As will be described later in greater detail, the circuits enable interaction between the transmitter 10 and the radio-controlled car 12 so that the radio-controlled car 12 may be controlled via the transmitter 10. An antenna 18 may be provided on the radio-controlled car 12 to receive radio signals from an antenna 20 of the transmitter 10.

The transmitter 10 includes a housing 24 for enclosing the circuits. A user may interact with the circuits using a plurality of control devices disposed on the transmitter 10. These control devices may include a power switch 26, a channel selection switch 28, an indicator 30, a steering member 32, a steering adjuster 34, a left hand/right hand selection switch 36, a release button 38, and a motion control member 40. It is understood that the number, type, and arrangement of control devices on the transmitter 10 illustrated in FIGS. 1-3 are for purposes of example, and that alternate numbers and/or types of control devices may be provided. For example, the channel selection switch 28 may be any user input means, including but not limited to a rotatable knob, or a voice-recognition circuit. An indicator housing 42 may be used to protect the indicator 30.

As illustrated, in the present example, the power switch 26, the channel selection switch 28, the indicator 30, the steering member 32, and the release button 38 are provided on a front surface 44 of the transmitter 10, while the steering adjuster 34 is provided on a side 46 of the transmitter 10, and the left hand/right hand selection switch 36 is provided on a top surface 86 of the transmitter. Furthermore, the motion control member 40 extends from the transmitter 10 into a cutout 48 formed through the transmitter 10.

The steering member 32 and the motion control member 40 enable the movement of the radio-controlled car 12 to be controlled. The steering member 32 may include an annular portion 50, which is radially spaced from a central portion 52. The central portion 52 is the portion of the steering member 32 that extends into the housing 24 to operatively connect with a left/right steering circuit as will be described later with respect to FIG. 5C. The steering member 32 may further include a plurality of radially-extending legs 54 for connecting the annular portion 50 with the central portion 52. The steering member 32 may be removably connected to the transmitter 10 in any conventional manner, such as a snap-fit.

The steering adjuster 34 on the transmitter 10 may be used to ensure proper wheel alignment (e.g., to correct “drift”) in the steering of the radio-controlled car 12. For example, if the transmitter 10 is directing the radio-controlled car 12 to drive in a straight line, but the radio-controlled car 12 is veering to the right, the steering alignment may be adjusted via the steering adjuster 34 so that the radio-controlled car 12 proceeds in a straight line as directed.

In the present example, the steering adjuster 34 is a wheel, which is initially in a neutral position. Rotating the steering adjuster 34 adjusts the signal that is transmitted by the transmitter 10 to the radio-controlled car 12. For example, if the transmitter 10 transmits instructions to the radio-controlled car 12 using a series of pulses (e.g., pulse modulation), then the steering adjuster 34 may be rotated to a non-neutral position to alter the transmitted pulses so that they represent a neutral state. For example, a potentiometer responsive to the rotation of the steering adjuster 34 may be used to alter a pulse width of the transmitted pulses.

The motion control member 40 may include an extension portion 68 and an inverted U-shaped portion 70. The inverted U-shaped portion 70 provides a groove 72 through which the user may insert a finger to control movement of the motion control member 40 in a substantially right or left direction. Movement of the motion control member 40 from a neutral position instructs the transmitter 10 to signal the radio-controlled car 12 to move either forward or backward. The direction of movement may be dependent on the left hand/right hand selection switch 36, as will be described further with respect to the operation of the radio-controlled car 12 and a left hand/right hand selection circuit of FIG. 5A.

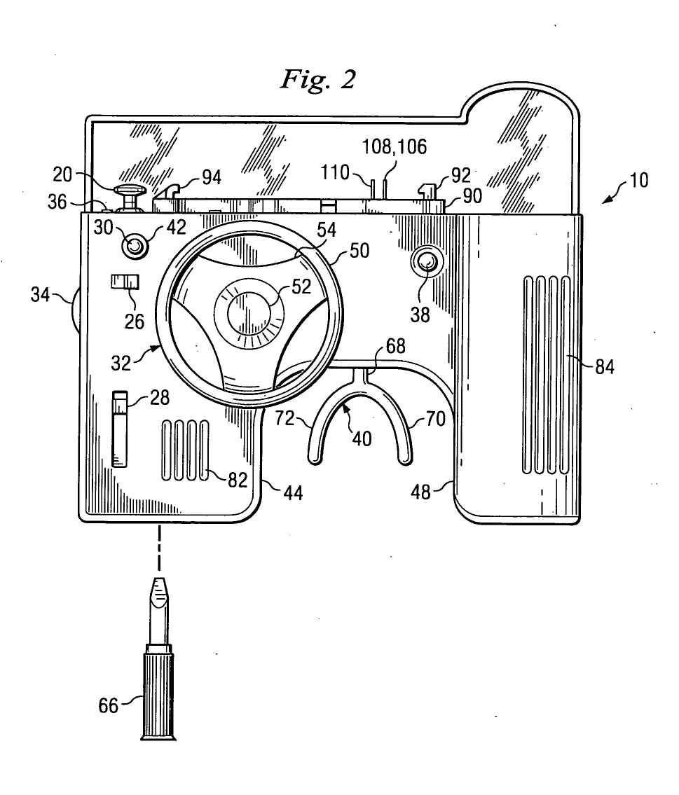

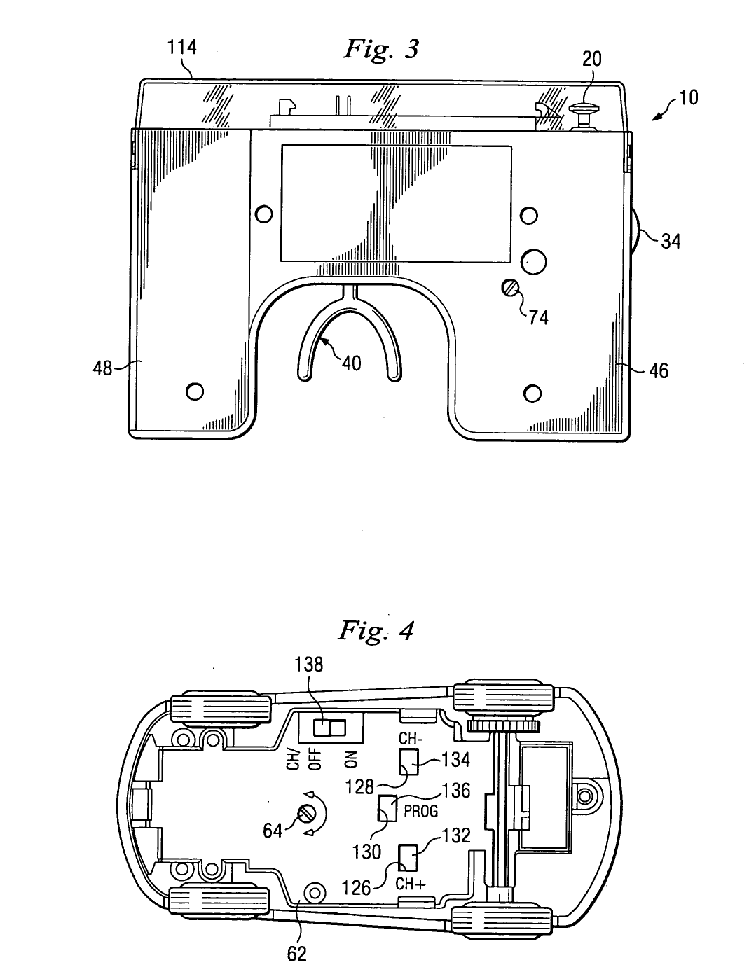

The transmitter 10 may also include a motion control trimmer 74 (FIG. 3), which may be adjustable via a tool 66 (FIG. 2), such as a screwdriver. In one example, the tool 66 may be housed in the transmitter 10 during nonuse as illustrated by the exploded view of the tool in FIG. 2. The motion control trimmer 74 may be used to compensate for undesired forward or backward motion of the radio-controlled car 12. For example, if the radio-controlled car 12 moves in a forward or backward direction when the motion control member 40 is in a neutral position, the motion control trimmer 74 may be adjusted so that the radio-controlled car 12 remains stationary unless the motion control member 40 is moved from its neutral position. As described previously with respect to the steering adjuster 34, the motion control trimmer 74 may operate via a potentiometer that adjusts a characteristic of the signal transmitted to the radio-controlled car 12.

Referring now to the front surface 44 of the transmitter 10, the cutout 48 generally defines a left portion 76, a right portion 78, and a middle portion 80 of the front surface. A gripping means 82 may be formed in the left portion of the front surface for providing a left-hand gripping surface for the user. The gripping means 82 may be any non-uniform surface that aids the user in gripping the transmitter 10. For example, the gripping means 82 may be a plurality of channels formed in the transmitter. The right portion 78 of the front surface 44 protrudes relative to the left portion 76 and is generally curved to provide a right-hand gripping surface for the user. A gripping means 84 may be formed in the right portion 78 of the front surface 44 to further aid in providing the right-hand gripping surface.

Referring now to the top surface 86 of the transmitter 10, an interface pad 90 is adapted to couple the radio-controlled car 12 to the transmitter 10 during selection of an operating frequency and charging of a battery (not shown) housed within the radio-controlled car 12. It is understood that selection of the operating frequency and charging of the battery may be accomplished independently of one another. For example, the operating frequency of the car 12 may be changed even if the car is fully charged. It is further understood that changing of the frequency may be accomplished using alternate interfaces such as via an infrared port or wirelessly using a radio frequency. For example, if the frequency is changed wirelessly using a radio frequency, the transmitter 10 and the car 12 may each include a memory or timer for monitoring a defined amount of time. At the end of the defined amount of time, the transmitter 10 and the car 12 will simultaneously switch over to the new frequency.

In the present example, a pair of catches 92 and 94 extend through the interface pad 90 to couple the chassis 16 of the radio-controlled car 12 to the interface pad 90 during charging. The catches 92 and 94 may also aid in aligning the radio-controlled car 12 on the interface pad 90. The release button 38 is operatively connected to the catches 92 and 94, such that depression of the release button 38 releases the radio-controlled car 12 from the interface pad 90. A portion of the top surface 86 of the transmitter 10 may be formed as a removable cover 96 for providing access to a battery housing (not shown) disposed within the transmitter.

A plurality of slots 100, 102, and 104 are formed in the interface pad 90 to provide external access to a pair of electrical charging contacts 106 and 108 and an electrical programming contact 110, respectively. It is understood that the orientation of contacts extending from the transmitter 10 is variable, and that additional contacts may be used. A charging button 112 may be further provided through the interface pad 90 for contacting the chassis 16, as will be described later with respect to the operation of the radio-controlled car 12 and a charging circuit of FIG. 5E.

A cover 114 may be used to enclose and protect the interface pad 90 and the antenna 20 during nonuse. The housing 24 includes a step-down portion 116 for accommodating movement of the cover 114 from an open position to a closed position. A protrusion 118 extends from the step-down portion 116 for receiving a corresponding bore 120 formed through a flange 122 of the cover 114 for connecting the cover to the housing 24.

Referring now to FIG. 4, a bottom surface 62 of the chassis 16 may include a steering trimmer 64. Like the steering adjuster 34 of the transmitter 10, the steering trimmer 64 may be used to ensure proper wheel alignment in the steering of the radio-controlled car 12. For example, if the transmitter 10 is directing the radio-controlled car 12 to drive in a straight line, but the radio-controlled car 12 is veering to the right, then the steering alignment may be adjusted via the steering trimmer 64 so that the radio-controlled car 12 proceeds in a straight line as directed. Although the steering adjuster 34 and steering trimmer 64 may be used separately, it is understood that they may enable a larger adjustment to be made to the steering alignment when used together.

In the present example, the steering trimmer 64 is initially in a neutral position. Rotating the steering trimmer 64 adjusts the way in which the radio-controlled car 12 responds to the signal that is received from the transmitter 10. For example, if the transmitter 10 transmits instructions to the radio-controlled car 12 using a series of pulses (e.g., pulse modulation), then the steering trimmer 64 may be rotated to a non-neutral position (either by hand or using a tool such as the screwdriver 66) to alter the received pulses so that they represent a neutral state. For example, a potentiometer responsive to the rotation of the steering trimmer 64 may be used to alter a pulse width of the transmitted pulses.

A plurality of slots 126, 128, and 130 are formed through the bottom surface 62 of the chassis 16 for allowing access to a pair of electrical charging contacts 132 and 134 and an electrical programming contact 136. The charging contacts 132 and 134 and the programming contact 136 of the car 12 correspond to the charging contacts 106 and 108 and the programming contact 110, respectively, of the transmitter 10. It is understood that the transmitter 10 and the car 12 may be connected for purposes of charging and programming by other means such as cables that connect into jacks associated with the transmitter and the car. A power switch 138 may further be provided on the bottom surface 62 of the chassis 16. Accordingly, when the radio-controlled car 12 is placed onto the interface pad 90 of the transmitter 10, circuits within the radio-controlled car 12 may electrically connect with corresponding circuits within the transmitter 10. Additionally, although not shown, the car 12 may include an indicator for indicating various operating states of the car, such as the operating frequency. The indicator on the car 12 may be provided in addition to, or in place of, the indicator 30 of FIG. 1.

Referring now to FIGS. 5A-5F, a plurality of circuits that may be housed within the transmitter 10 are illustrated. It is understood that relationships may exist between various circuits and/or circuit components of FIGS. 5A-5F. For example, the circuit of FIG. 5A includes a microcontroller unit (MCU) denoted by the reference number U203. The MCU U203 includes various input and output ports, including a POWER₁₃ LED output and a CHA_LED output. The POWER_LED and CHA_LED outputs serve as inputs to the LED circuit of FIG. 5F.

Referring now to FIG. 5A, a circuit 200 includes the MCU U203, a channel selection circuit 202, a left hand/right hand selection circuit 204, and a MCU control circuit 206. For purposes of example, the MCU U203 is an EM78458, made by Elan Microelectronics, with 4K of read only memory (ROM). The memory of the MCU U203 includes a plurality of instructions for controlling various aspects of the transmitter 10. For example, in conjunction with various circuits, the MCU U203 may program a selected frequency of the radio-controlled car 12, handle charging, control steering and left/right and front/back motion, and perform other tasks.

The channel selection circuit 202 is associated with the channel selection switch 28 of FIG. 1 through switches SW203-SW205 and SW207-SW209, each of which corresponds to a channel 1-6 of the channel selection switch 28. It is understood that any number of channels are contemplated. In the present example, only one of the switches SW203-SW205 and SW207-SW209 can be in a closed state (e.g., if channel 1 is selected, SW203 may be closed, while SW204, SW 205, SW207-SW209 may be open). The state of the switches (e.g., open or closed) may be read by the MCU U203 as a voltage through an analog to digital converter that is contained within the MCU U203. This state informs the MCU U203 of the user-selected channel that is to be used by the transmitter 10 and the radio-controlled car 12. After the selected channel is confirmed by comparison of the read voltage to a predefined value within the MCU U203, the MCU U203 may program an integrated circuit (e.g., IC U201 of FIG. 5D) through a CHCLK signal pin. This sets the transmitter 10 to transmit signals using the selected channel.

The MCU U203 may then transfer information regarding the user-defined channel to an MCU U2 (FIG. 6A) within the radio-controlled car 12 via the programming contact 110. In the present example, channel programming of the radio-controlled car 12 may be accomplished when the radio-controlled car 12 is placed onto the interface pad 90. In some embodiments, the programming may occur in a predefined period of time, such as during the first eight seconds of a charging cycle. For example, if a user desires to change the channel from 3 to 4, he may push the channel selection switch 28 one step upwards. This changes the input voltage at pins 6 and 7 of the MCU U203, and the MCU U203 detects the selection of channel 4 by comparing the detected voltage level with an internal threshold level. The MCU U203 then sets the transmitter 10 to transmit using the selected channel and transfers the selected channel to the radio-controlled car 12.

The left hand/right hand selection circuit 204 is associated with the left hand/right hand selection switch 36 of FIG. 1 through a switch SW206. In the present example, moving the left hand/right hand selection switch 36 on the transmitter 10 from right hand to left hand (or vice versa) reverses the operation of the motion control member 40 by reversing an FB+ contact and a FB− contact (FIG. 5B). This enables the transmitter 10 to be adjusted for use with both right and left-handed users.

With additional reference to FIGS. 5G and 5H, one embodiment of the left hand/right hand selection switch 36 (and the corresponding switch SW206 of FIG. 5A) is associated with six contact points A-F. The contact A is of positive polarity and the contact B is of negative polarity. Contact A is connected to contact F, and contact B is connected to contact E. For purposes of illustration, contact C is connected to the FB+ contact (FIG. 5B) and contact D is connected to the FB− contact (FIG. 5B).

When the switch SW206 is set for right-handed use (FIG. 5G), the contacts A and C are connected, and the contacts B and D are connected. This gives the contact C (and the associated contact FB+) a positive polarity, and gives the contact D (and the associated contact FB−) a negative polarity. When the switch SW206 is set for left-handed use (FIG. 5H), the contacts C and E are connected, and the contacts D and F are connected. This reverses the polarity of the contacts C and D, giving the contact C (and the associated contact FB+) a negative polarity, and giving the contact D (and the associated contact FB−) a positive polarity. Accordingly, by manipulating the polarity of the FB+ and FB− contacts via the contacts A-F, the transmitter 10 may be set for right-handed or left-handed use.

Referring now to FIG. 5B, a forward/backward motion control circuit 210 housed within the transmitter 10 is associated with the motion control member 40 (FIG. 1) through an input FBC. Movement of the motion control member 40 affects variable resistor VR201, which may be a potentiometer, as described previously. The output voltage F/B of the forward/backward motion control circuit 210 is read by the MCU U203 (FIG. 5A) on pin 3, and the MCU U203 determines what digital signals to send to the radio-controlled car 12 based on the read voltage. As described previously, the transmitter 10 may include a motion control trimmer 74 (FIG. 3) that can be used to offset undesired forward or backward motion when the radio-controlled car 12 is supposed to remain stationary. In the present example, the motion control trimmer 74 is associated with a variable resistor VR204.

Referring now to FIG. 5C, a left/right steering control circuit 212 housed within the transmitter 10 is associated with the steering member 32 (FIG. 1) through an input LRC. Movement of the steering member 32 affects variable resistor VR202, which may be a potentiometer, as described previously. The output voltage L/R of the left/right steering circuit 212 is read by the MCU U203 (FIG. 5A) on pin 4, and the MCU U203 determines what digital signals to send to the radio-controlled car 12 based on the read voltage. As described previously, the transmitter 10 may include a steering adjuster 34 (FIG. 1) that can be used to offset undesired drift in the wheel alignment of the radio-controlled car 12. In the present example, the steering adjuster 34 is associated with variable resistor VR203.

Referring now to FIG. 5D, a signal transmission circuit 214 housed within the transmitter 10 is used to transmit control signals from the transmitter 10 to the radio-controlled car 12. The signal transmission circuit 214 includes a transistor Q206, a varactor diode D201, an antenna ANT1 (which may be the antenna 20 of FIG. 1), a crystal X201, and an integrated circuit (IC) U201, which may be an ET13X221, made by Etoms Electronics. Although not shown in FIG. 5D, the IC U201 includes a phase lock loop circuit, a voltage controlled oscillator, and a crystal oscillator. In the present example, the voltage controlled oscillator within the IC U201 is operated at 27 MHz by programming a frequency counter within the IC U201 via an input port CHCLK (pin 1 of the IC U201). The IC U201 has sixteen available channels.

Data is sent from the MCU U203 to the radio-controlled 12 via an output port DATA_OUT (pin 19, FIG. 5A) as follows. When a square-wave is generated by the MCU U203 on the DATA_OUT port and applied through the resistor R211, the carrier signal is frequency shift key (FSK) modulated (e.g., it enables sub-carrier modulated signaling that can be used for data transmission, where binary ones and zeroes are represented by two different frequencies that are offset from the carrier frequency). The data is then sent to the radio-controlled car 12 via the antenna ANT1.

Referring now specifically to FIG. 5E, a charging circuit 216 housed within the transmitter 10 may be used in charging the radio-controlled car 12. In the present example, the charging circuit 216 includes a power switch SW201, a charging switch SW202 and associated contact pads CH+ and CH−, each of which correspond to an element of FIG. 1. For example, the power switch SW201 may be connected to the power switch 26, the charging switch SW202 may be connected to the charging button 112, and the contact pads CH+ and CH− may correspond to the electrical charging contacts 106, 108, respectively.

In operation, the power switch 26 of the transmitter 10 is turned to “on,” which actuates the power switch SW201 of the charging circuit 216, providing an electrical connection to a battery BATT. (In the present example, the power switch 138 of the radio-controlled car 12 is also turned to “on” prior to placement of the radio-controlled car 12 on the transmitter 10.) When the radio-controlled car 12 is placed onto the interface pad 90 of the transmitter 10, the charging button 112 is depressed, actuating the charging switch SW202. When the charging switch SW202 is actuated, the MCU U203 (FIG. 5A) alters the state of pin 13 and turns on transistor Q203 (which then turns on transistors Q202, Q207, and Q208). This provides power from the battery BATT to the contact pads CH+ and CH−. A timer is started within the MCU U203 to limit the amount of time that the battery of the radio-controlled car 12 is allowed to charge, thereby preventing an overcharge from occurring and damaging the battery. In the present example, the charging duration is approximately one minute and the charging rate is approximately 10C (where C is the one hour discharge current). An IC U202 provides a regulated voltage output to the MCU control circuit 206 (FIG. 5A) and the signal transmission circuit 214 (FIG. 5D).

Referring now to FIG. 5F, a light emitting diode (LED) circuit 218 housed within the transmitter 10 powers the indicator 30 to indicate an operating state of the transmitter 10. In the present example, the indicator 30 comprises one or more LEDs that are used to represent a variety of states using one of three colors that may be blinking or steady. For example, green and steady may indicate that the transmitter 10 is powered on or in trickle charge mode; red and blinking may indicate that channel programming (of the radio-controlled car 12) is in progress; red and steady may indicate that the radio-controlled car 12 is being charged; and amber and steady may indicate that channel programming has failed. It is understood that these states are exemplary, and that other states and/or combinations may be used. These states are controlled by the MCU U203 (FIG. 5A) via a POWER₁₃ LED output (pin 14) and a CHA_LED output (pin 11).

Referring now to FIGS. 6A-6D, a plurality of circuits that may be housed within the radio-controlled car 12 are illustrated. It is understood that relationships may exist between various circuits and/or circuit components of FIGS. 6A-6D. For example, the circuit of FIG. 6A includes a MCU denoted by the reference number U2. The MCU U2 includes various input and output ports, including a W2R output and a W2L output. The W2R and W2L outputs serve as inputs to the motor control circuit of FIG. 6B.

Referring now to FIG. 6A, a circuit 220 includes the MCU U2, an IC U1, a low noise amplifier circuit 222, a receiver circuit 224, and a MCU control circuit 226. For purposes of example, the MCU U2 may be an EM78458, made by Elan Microelectronics, and the IC U1 may be an ET13X210, made by Etoms Electronics. The MCU U2 may include a plurality of instructions for controlling various aspects of the radio-controlled car 12. For example, in conjunction with various circuits, the MCU U2 may control steering and forward/backward motion.

The channel information transferred from the MCU U203 (FIG. 5A) is received by the MCU U2. The user selected channel may be stored in memory associated with the MCU U2, which may then set the radio-controlled car 12 to receive signals using the selected channel by setting the IC U1 via pins D0-D3. In the present example, as the channel data is stored in volatile memory, it will be lost when power is lost or reset occurs, but will be reprogrammed again when the battery is charged.

The FSK modulated signal transmitted by the transmitter 10 via the antenna 20 is received by an antenna ANT2 (which may be the antenna 18 of FIG. 1) associated with the low noise amplifier circuit 222. The received signal is amplified by the low noise amplifier circuit 222 and passed to the IC U1, which mixes the signal down to an intermediate frequency. The intermediate frequency signal is then demodulated and waveform shaped to recover the original control data stream. The data stream is then decoded by the MCU U2 and used to control a first motor control circuit 228 (FIG. 6B) and a second motor control circuit 230 (FIG. 6C), which control steering of the front wheels and forward/backward motion, respectively.

More specifically, the MCU U2 controls the front wheels via two output ports W2R (pin 8) and W2L (pin 9), which correspond to circuit inputs of the same name in FIG. 6B. The steering trimmer 64 may be associated with the circuit of FIG. 6B to enable a user to manipulate the circuit in order to align the front wheels of the radio-controlled car 12. For example, the steering trimmer 64 may be associated with a variable resistor (not shown) as described previously with respect to the circuit elements VR204 and VR203 of FIGS. 5B and 5C, respectively. Similarly, the MCU U2 controls forward/backward motion via two output ports WIF (pin 6) and WIB (pin 7), which correspond to circuit inputs of the same name in FIG. 6C. Although not shown in the present example, a user-adjustable component may be associated with the circuit of FIG. 6C to enable a user to manipulate the circuit in order to adjust the forward/backward motion of the radio-controlled car 12. For example, such component may be associated with a variable resistor (not shown) as described previously.

Referring now to FIG. 6D, a DC-DC converter circuit 232 includes a switch SW1, contact pads CH+ and CH−, and a DC-DC converter U3. The switch SW1 corresponds to the power switch 138, and the contact pads CH+ and CH− may correspond to the electrical charging contacts 132, 134 (FIG. 4), respectively. When the switch SW1 is closed, power is provided to the circuit 232. The DC-DC converter U3 steps the battery voltage up from 2.4V to 3V.

To operate the radio-controlled car 12, a user turns both the power switch 26 of the transmitter 10 and the power switch 138 of the radio-controlled car 12 to “on.” The indicator 30 may emit a green color to indicate that the transmitter 10 is on. If the battery of the radio-controlled car 12 is to be charged or the car is to be programmed with a different frequency, the radio-controlled car 12 is placed on the interface pad 90 of the transmitter 10 to engage the catches 92 and 94. By placing the radio-controlled car 12 on the interface pad 90, the charging button 112 of the transmitter 10 is activated, which begins the charging process of the radio-controlled car 12 via the electrical connection between the charging contacts 132 and 134 of the radio-controlled car 12 and the charging contacts 106 and 108 of the transmitter 10.

During charging, the operating frequency of the radio-controlled car 12 and the transmitter 10 may be modified by moving the channel selection switch 28 to a desired operating channel. The indicator 30 may emit a blinking red color to indicate channel frequency programming. Upon frequency selection, the indicator 30 may emit a steady red color to indicate charging. When the charging process is completed, the indicator 30 may emit a green color.

If channel programming fails, the indicator 30 may emit an amber color to indicate such failure. The user may then remove the radio-controlled car 12 from the transmitter 10 to clear the programming failure, and then reposition the radio-controlled car 12 on the transmitter 10 to restart the charging and programming operations.

When the selected operating frequency is programmed and the radio-controlled car 12 has been charged, the radio-controlled car 12 may be removed from the transmitter 10 by pressing the release button 38. Prior to controlling the radio-controlled car 12, the user may configure the transmitter 10 for right or left-handed use. For example, a right-handed user may move the left hand/right hand selection switch 36 to the “right” position, which configures the motion control member 40 to impart forward motion to the radio-controlled car 12 when the motion control member is moved in a left direction and to impart backward motion to the car when the motion control member is moved in a right direction. Generally, a right-handed user may control the steering member 32 using the left hand while manipulating the motion control member 40 with the right hand. If the alternative configuration is desired, the user may move the left hand/right hand selection switch 36 to the “left” position.

The radio-controlled car 12 may then be controlled by gripping the transmitter 10 and moving the steering member 32 and the motion control member 40. If the wheel alignment of the radio-controlled car 12 drifts during neutral steering, then the steering trimmer 64 and/or the steering adjuster 34 may be adjusted. Additionally, if the radio-controlled car 12 moves when the motion control member 40 is in a neutral position, the motion control trimmer 74 may be adjusted accordingly.

The present invention has been described relative to a preferred embodiment. Improvements or modifications that become apparent to persons of ordinary skill in the art after reading this disclosure are deemed within the spirit and scope of the application. For example, a variety of alternate circuit configurations and components may be used to achieve the functionality of the circuits described above. Furthermore, alternate controls may be provided that accomplish similar functions to those described herein. Still further, functionality such as adjustments to the steering and/or to the forward/backward motion may be automatically achieved via one of the microcontrollers housed within the transmitter 10 or the car 12. Accordingly, it is understood that several modifications, changes and substitutions are intended in the foregoing disclosure and, in some instances, some features of the invention will be employed without a corresponding use of other features. It is also understood that all spatial references, such as “right”, “left,” “longitudinal,” “radial,” “top,” “side,” “back,” and “front” are for illustrative purposes only and can be varied within the scope of the disclosure. Accordingly, it is appropriate that the appended claims be construed broadly and in a manner consistent with the scope of the invention.

1. A transmitter for a radio-controlled toy, wherein the transmitter is adaptable for left-handed or right-handed use, the transmitter comprising:
a selector for selecting left-handed or right-handed use of the transmitter;
at least one control member, wherein actuation of the control member causes a predefined response by the toy when the selector is set for right-handed use; and
selection circuitry associated with the selector and the control member, wherein the circuitry reverses the predefined response upon actuation of the control member when the selector is set for left-handed use.

2. The transmitter of claim 1 wherein the selection circuitry includes a microcontroller unit, and wherein the microcontroller unit includes a plurality of instructions for reading an output of the selection circuit to determine if the selector is set for right-handed or left-handed use, sending a first signal representing the predefined response if the selector is set for right-handed use, and sending a second signal representing the reverse of the predefined response if the selector is set for left-handed use.

3. The transmitter of claim 2 further comprising a signal transmission circuit for receiving the first or second signal from the microcontroller and transmitting the received first or second signal to the toy.

4. The transmitter of claim 1 further comprising a housing, wherein the selector is positioned proximate to a surface of the housing.

5. The transmitter of claim 1 further comprising:
a control circuit for generating an output representing actuation of the control member; and
a trimmer associated with the control circuit for modifying the output of the control circuit.

6. The transmitter of claim 5 wherein the trimmer includes a user controllable interface for enabling user modification of the output of the control circuit.

7. The transmitter of claim 5 wherein the trimmer is a variable resistor.

8. The transmitter of claim 1 wherein the control member comprises an extension portion and a groove portion.

9. The transmitter of claim 8 wherein the groove portion is substantially an inverted U-shape.

10. The transmitter of claim 1 wherein, when the selector is set for right-handed use, actuation of the control member in a first direction imparts forward motion to the toy, and actuation of the control member in a second direction imparts backward motion to the toy.

11. The transmitter of claim 10 wherein, when the selector is set for left-handed use, actuation of the control member in the first direction imparts backward motion to the toy, and actuation of the control member in the second direction imparts forward motion to the toy.

12. A transmitter for a radio-controlled toy, the transmitter being adaptable for a left-handed or right-handed user, the transmitter comprising:
a housing having a cutout formed therein;
a configuration circuit positioned within the housing;
a configuration switch on the housing and in electrical communication with the configuration circuit, the configuration switch being selectable between a left position and a right position, wherein the left position configures the transmitter for use by a left-handed user and the right position configures the transmitter for use by a right-handed user; and
a control member positioned in the cutout of the housing, the control member being movable in a first direction and a second direction, the first and second directions being substantially opposite directions,
wherein movement of the control member imparts motion to the radio-controlled toy, such motion being dependent upon the setting of the configuration switch.

13. The transmitter of claim 12 further comprising:
a control circuit in electrical communication with the control member for producing an output representing movement of the control member in the first and second directions; and
a signal transmission circuit for receiving the output from the control circuit and transmitting the output to the radio-controlled toy.

14. The transmitter of claim 13 further comprising a microcontroller unit having a memory, wherein the memory includes a plurality of instructions for processing by the microcontroller unit, the instructions for:
receiving the output from the control circuit;
processing the output for sending to the radio-controlled toy; and
transferring the output to the signal transmission circuit.

15. The transmitter of claim 13 further comprising a trimmer associated with the control circuit for modifying the output of the control circuit.

16. The transmitter of claim 12 further comprising a gripping means formed on a front surface of the transmitter to provide a gripping surface.

17. A method for altering a behavior of a transmitter depending on whether the transmitter is configured for use by a right-handed or left-handed user, wherein the transmitter includes a selector associated with a configuration circuit, the method comprising:
reading an output of the configuration circuit to determine whether the selector is set for right-handed or left-handed use;
generating a first signal if the selector is set for right-handed use and generating a second signal different from the first signal if the selector is set for left-handed use; and
transmitting the first or second signal to a radio-controlled toy being controlled by the transmitter, wherein a behavior of the radio-controlled toy is dependent on whether the selector is set for right-handed or left-handed use.

18. The method of claim 18 further comprising reading an output of a control circuit to determine a position of a control member, wherein the output of the control circuit is represented by the first signal if the selector is set for right-handed use and by the second signal if the selector is set for left-handed use.

19. The method of claim 19 further comprising altering the output of the control circuit using a trimmer.

20. A system for correcting steering drift in a radio-controlled toy, the system comprising:
a radio transmitter having steering control circuitry for receiving steering input, a steering adjuster associated with the steering control circuitry for correcting steering drift associated with a radio-controlled toy, and signal transmission circuitry for transmitting radio signals from the steering control circuitry; and
the radio-controlled toy having motor control circuitry for steering the toy using the radio signals from the transmitter, and a trimmer associated with the motor control circuitry, the trimmer being adjustable to correct steering drift associated with the toy.

21. The system of claim 20 wherein the steering adjuster corrects steering drift by altering an output of the steering control circuitry.

22. The system of claim 20 wherein the steering adjuster and the trimmer correct a larger degree of drift when used together than when used separately.
